(19) United States
(12) Patent Application Publication
(10) Pub. No.: US 2007/0290846 A1
(43) Pub. Date: Dec. 20, 2007

(54) Concept for determining the position or orientation of a transponder in an RFID system

(76) Inventors: Meinhard Schilling, Wolfenbuettel (DE); Martin Oehler, Braunschweig (DE); Uwe Wissendheit, Erlangen (DE); Dina Kuznetsova, Erlange (DE); Heinz Gerhaeuser, Waischenfeld (DE)

Correspondence Address: GLENN PATENT GROUP, 3475 EDISON WAY, SUITE L, MENLO PARK, CA, 94025, US

(21) Appl. No.: 11/422,831

(22) Filed: Jun. 7, 2006

(30) Foreign Application Priority Data
Jun. 7, 2006 (DE) 102006026495.9

(51) Int. Cl. G08B 13/14; G01S 13/08; G08B 21/00

(52) U.S. Cl. 340/572.1; 340/686.6; 342/139

(57) ABSTRACT

A method for determining the position or orientation of a transponder by inductive coupling in a radio system, wherein the radio system includes a transceiver having antenna means, comprising a step of generating a magnetic alternating field by means of the transceiver and the antenna means and a step of determining an association signal representing a measure of inductive coupling between the antenna means of the transceiver and the transponder, wherein a distance or orientation of the transponder to the antenna means may be associated to the inductive coupling.

### CROSS REFERENCE TO RELATED APPLICATIONS

This application claims priority to German Patent Application No. 102006026495.9, filed Jun. 07, 2006, all of which is herein incorporated in its entirety by this reference thereto.

The present invention relates to a method and a system for determining the position, orientation and/or motion of a transponder by inductive coupling in a radio system, in particular in an RFID (radio frequency identification) system.

The so-called RFID technology has been employed for some time in, among other sectors, automatic identification of goods, persons, products and animals. RFID technology is a radio-based contact-free identification method which originally employed radio frequencies in the radio frequency range (100 kHz up to several 10 MHz), wherein frequencies up to the microwave range are being used today. Advantages of these systems over, for example, barcode systems are, among other things, a considerably higher capacity, insensitivity towards environmental influences and pollution, considerably higher range or coverage and the possibility of reading out several transponders (made up of transmitters and responders) simultaneously.

A transponder is the actual tag carrying information, such as, for example, of goods, and communicating with a stationary or mobile reader or transceiver. Depending on the system setup, this communication allows reading and writing the transponder, allowing additional flexibility for the system. Alterations in product data at a later time thus can be made easily. Another advantage of RFID systems is the possibility of using passive transponders which can do without their own energy supply and can thus be set up in a correspondingly compact manner.

FIG. 18 shows a typical setup of an RFID system. Such a system typically includes one or several readers or transceivers 10 and a plurality of transponders 11. Both the reader 10 and the transponder 11 reach include an antenna 12, 13 which influences a range of the communication between the reader 10 and the transponder 11 to a decisive degree. If the transponder 11 gets near the antenna 12 of the reader 10, they (transponder and reader) will exchange data. Apart from the data, the reader 10 transmits also energy to the transponder 11. An antenna coil which is exemplarily embodied as a frame antenna or ferrite antenna is provided within the transponder 11. For operating the transponder 11, the reader 10 at first produces a high-frequency magnetic alternating field by means of its antenna 12. In addition, the antenna 12 includes a large-area coil having several turns. If the transponder 11 is placed close to the reader antenna 12, the field of the reader will produce an induction voltage in the coil of the transponder 11. This induction voltage is rectified and serves for supplying a voltage to the transponder 11. A capacity is generally connected in parallel to an inductivity of the transponder coil. The result is a parallel resonant circuit. The resonant frequency of this resonant circuit corresponds to the transmitting frequency of the RFID system. At the same time, the antenna coil of the reader 10 is resonated by an additional capacitor in a series or parallel connection.

Additionally, a clock frequency which is available for a memory chip or a microprocessor of the transponder 11 as a system clock is derived from the alternating voltage induced in the transponder 11. The data transmission from the reader 10 to the transponder 11, in the simplest case, takes place by so-called amplitude shift keying (ASK) where the high-frequency magnetic alternating field is switched on and off. The reverse data transmission from the transponder 11 to the reader 10 utilizes the features of the transforming coupling effect between the reader antenna 12 and the transponder antenna 13. Thus, the reader antenna 12 represents a primary coil and the transponder antenna 13 represents a secondary coil of a transformer including a reader antenna and transponder antenna.

Due to the often very small electromagnetic coupling between the reader antenna 12 and the transponder antenna 13, it must be expected that the modulation signals at the antenna 12 of the reader 10 are very small. The coupling mostly is smaller than 10%, sometimes even below 1%. The load-modulation signals are by about 60 dB to 80 dB weaker than the carrier signal.

In the region of short-range localization of objects, systems for applications in the range of logistics are, for example, known. Binary localization (transponder present/not present) is widely used in logistics, i.e. registration of objects at one or several locations known before.

In contrast, raster localization, for example, is used for inputting a position of a point into a computer. Several conductors arranged next to one another in the region of the positional measurement are activated one after the other. Thus, the position when exciting the certain conductor is calculated from two components.

Patent document DE 4400946 C1, for example, describes position detection means having a position detection region where several conductors are provided which are arranged next to one another in the direction of the positional measurement, a selection circuit for selecting individual conductors, a transmitting circuit providing a transmit signal to a selected conductor, a position indicator having a resonant circuit which is excited to oscillate by the transmit signal and emits a receive signal, a receiving circuit for detecting the receive signal in a selected conductor, processing means for determining the position indicated by the position indicator by processing the receive signals detected by the receiving circuit, wherein the resonant circuit continually transfers energy.

Another principle of radio localization is localization by electromagnetic wave propagation. Thus, a receiver is integrated in an object sending its data to a sender when requested. The position of the object is then calculated from runtimes or the difference between two arriving signals.

Finally, there is another possibility of determining a position in utilizing the well-known radar principled exemplarily by means of the so-called backscattering method.

Existing systems for binary localization only offer low flexibility since their identification of a transponder is limited to a pure presence check. Typically, such systems are very imprecise and thus useless for many applications. For short-range localization, i.e. for determining the position of objects within a small range, systems utilizing radio localization by means of runtime measurement are not suitable because radio waves in the antenna near field typically have not yet detached from the antenna. Runtime methods are, however, based on the wave characteristic as is only present in the antenna distant field.

It is the object of the present invention to provide an improved concept for short-range localization of objects.

This object is achieved by a method according to claim 1, a device according to claim 20 and/or a transponder according to claim 35.

The present invention is based on the finding that position, direction and/or motion of a transponder arranged in the near field of the transceiver and inductively coupled to the transceiver can be determined by utilizing a transforming coupling effect of the transponder to the transceiver. At first, an electromagnetic or magnetic alternating field is generated or emitted from the antenna means associated to the reader by means of antenna means of a transceiver, i.e. by means of a reader. In the antenna near field, a purely magnetic alternating field can be assumed since the radio waves here have not yet detached from the antenna, whereas there is an electromagnetic wave propagation in the antenna distant field. Inventively, an electrical quantity in the form of an association signal representing a measure of the inductive coupling between the antenna means of the transceiver and the transponder is determined in the transceiver and/or in the transponder. This electrical quantity or the association signal exemplarily results from the response field strength or the reading field strength of the transponder or alterations thereof, from a field strength measurement of the magnetic alternating field at the transponder or from an evaluation of a load modulation caused by the transponder. According to the present invention, the fact is made use of that there is a connection between the inductive coupling between the transponder and the transceiver and a distance between the transponder and the transceiver. Thus, inventively the distance between the transponder and the transceiver can be associated to the electrical quantity determined, i.e. to the association signal.

This association of association signal and distance, in a first aspect of the present invention, is achieved by using a response minimum field strength and/or read minimum field strength of the transponder as an indicator for determining the distance from the transponder to the antenna means of the transceiver. The response field strength or response minimum field strength is that field strength where the transponder is still just operating properly, i.e. the field strength sufficient for a voltage supply of the transponder. The read field strength or read minimum field strength is the minimum field strength required for a communication between the transponder and the transceiver. This means that the read minimum field strength is greater than or equal to the response minimum field strength. If, for example, an antenna feed current of the antenna means of the transceiver is altered step by step or continually, the magnitude of the magnetic field produced by the antenna means at a certain location will change correspondingly. If the antenna feed current and thus the magnitude of the magnetic field produced is passed from a small starting value up to a maximum value or vice versa and if a transponder is within reach of the antenna means of the transceiver, the transponder will respond as soon as its required response minimum field strength or read minimum field strength is reached. Thus, to each antenna feed current at the transceiver a distance of the transponder from the antenna means can be associated.

An advantage of this aspect of the present invention is that conventional transponders may be employed and only one transceiver, i.e. the reader, has to be adjusted according to the invention to vary a current through antenna means of a transceiver and to be able to associate a transponder distance to a certain quantity of this current based on the response or read field strength calculated.

The association of the association signal and the distance can, in another aspect of the present invention, be achieved by determining, and exemplarily rectifying and smoothing, an analog voltage induced by the magnetic field produced by the transceiver, in the transponder, at a resonant circuit of antenna means of the transponder to obtain a direct voltage value corresponding to the voltage induced. This direct voltage value may be converted to a corresponding digital value by an analog-to-digital converter and can then be integrated and transferred as data in a corresponding data transfer protocol between the transponder and the transceiver. Optionally, the voltage in the transponder induced by the magnetic field may also be digitalized and processed directly, i.e. without rectifying, and smoothing. The transceiver can then filter out the digital field strength data integrated in the transfer protocol from the actual useful data of the communication so that it is available for evaluation, such as, for example, by means of a PC. The digital data transferred in this way thus is preferably proportional to the field strength of the magnetic alternating field at the transponder which in turn is a measure of the distance from the transponder to the transceiver.

This aspect of the present invention has the advantage that the measurement of the magnetic coupling takes place directly at the transponder and thus a really precise distance measurement is made possible.

The association of association signal and distance can, in another aspect of the present invention, be obtained by determining the association signal in the form of a first and/or second association signal and, in particular, of a so-called medium voltage and/or voltage swing at the transceiver, which are produced in an input circuit of the antenna means of the transceiver by load modulation of the transponder. The voltages determined at the transceiver thus form by a transforming coupling effect of the transponder to the transceiver which is proportional to the distance from the transponder to the transceiver. The medium voltage here corresponds to a direct voltage portion superimposed on the receive signal after demodulation, wherein the voltage swing exemplarily results from the carrier signal at the primary res on a nt circuit to be loaded in the rhythm of the data.

Advantages of this aspect according to the present invention are that conventional transponders may be employed. An inventive transceiver only requires processing means to associate a distance from the transponder to the transceiver to at least one of the two signals resulting from the transforming coupling effect, i.e. to the medium voltage or voltage swing.

The antenna means of an inventive transceiver may thus include one antenna or a plurality of antennas. The number of antennas determines in how many dimensions a position, direction and/or motion of a transponder inductively coupled to the transceiver can be determined.

Apart from the possibility of a pure identification of a transponder inductively coupled to a transceiver, there is, by means of the inventive concept, additionally inventively also the possibility of determining the position of the transponder, of determining an orientation of the transponder and the possibility of determining a motion of the transponder. Thus, it is possible to only modify the transceiver correspondingly so that conventional transponders may be used for localization.

Furthermore, the inventive concept offers the possibility of new service achievements and thus a basis for the development of new fields of application.

Preferred embodiments of the present invention will be detailed subsequently referring to the appended drawings, in which:

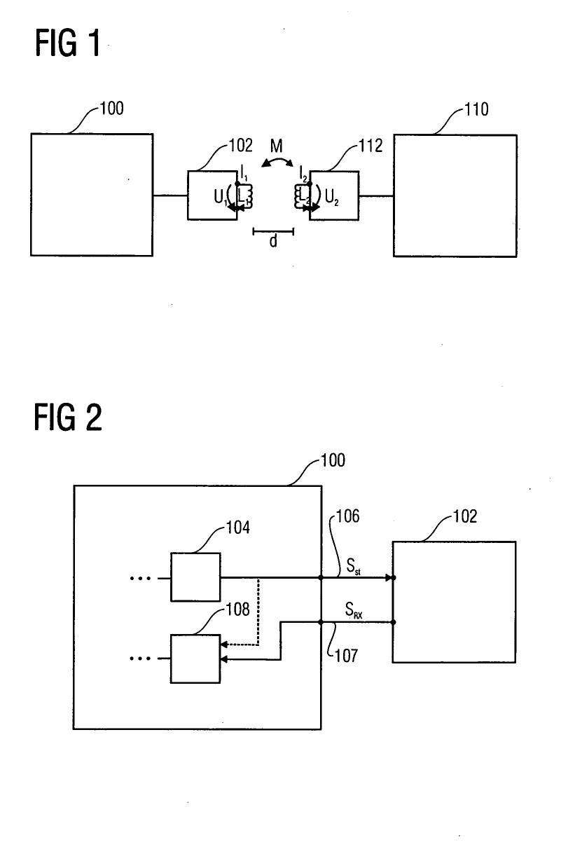

FIG. 1 shows a schematic setup of an inventive RFID system for illustrating the inductive coupling between a transceiver and a transponder;

FIG. 2 is a schematic illustration of a transceiver having antenna means according to an embodiment of the present invention;

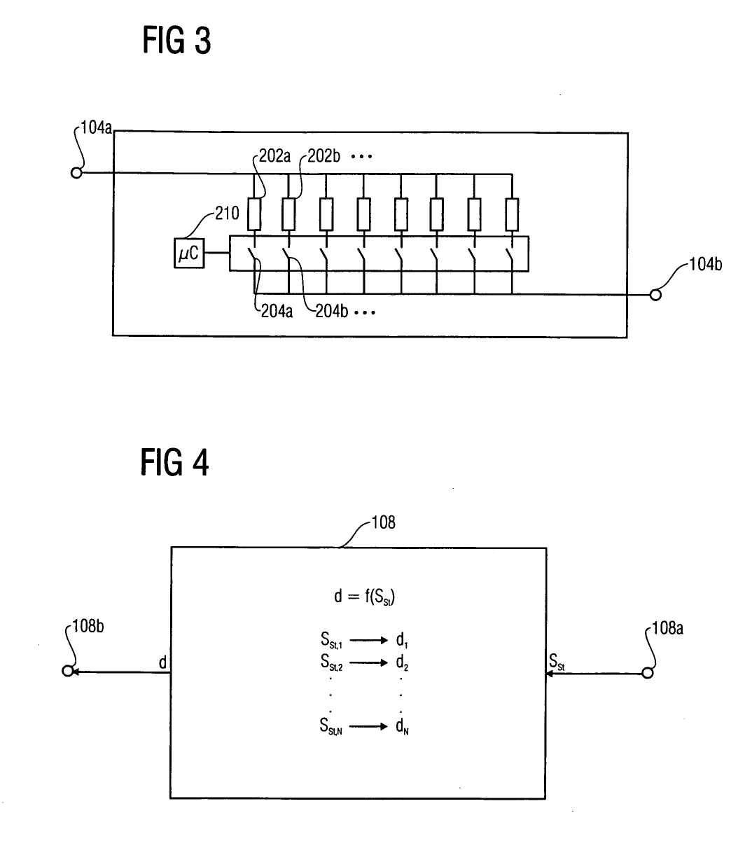

FIG. 3 shows a resistance network for controlling an antenna current of antenna means of the transceiver according to an embodiment of the present invention;

FIG. 4 is a schematic illustration of processing means of a transceiver according to an embodiment of the present invention utilizing a read or response minimum field strength of a transponder as an indicator for determining the distance of the transponder;

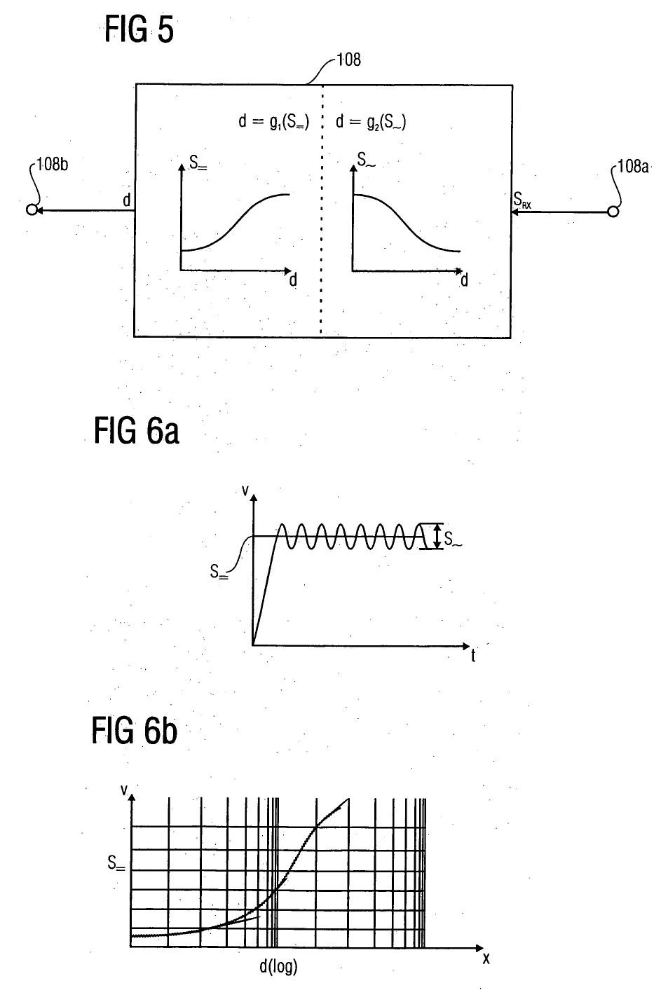

FIG. 5 is a schematic illustration of processing means of a transceiver according to an embodiment of the present invention utilizing a voltage at the antenna means of the transceiver as an indicator for determining the distance of the transponder;

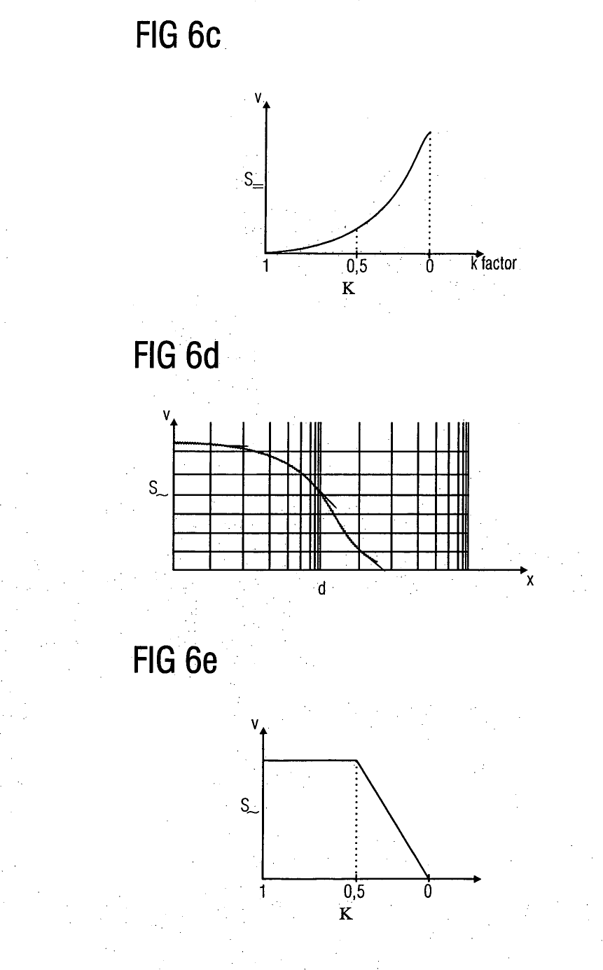

FIG. 6a is a schematic illustration of a connection between a first and a second association signal, in particular a medium voltage and a voltage swing measured at an antenna of a transceiver according to the present invention;

FIG. 6b is an exemplary illustration of a medium voltage measurement at a transceiver plotted against a distance from a transponder to a transceiver according to the present invention;

FIG. 6c shows a schematic course of a medium voltage at a transceiver plotted against a magnetic coupling factor of a transponder to a transceiver according to the present invention;

FIG. 6d is an exemplary illustration of a voltage swing measurement at a transceiver plotted against a distance from a transponder to a transceiver according to the present invention;

FIG. 6e shows a schematic course of a voltage swing at a transceiver plotted against a magnetic coupling factor of a transponder to a transceiver according to the present invention;

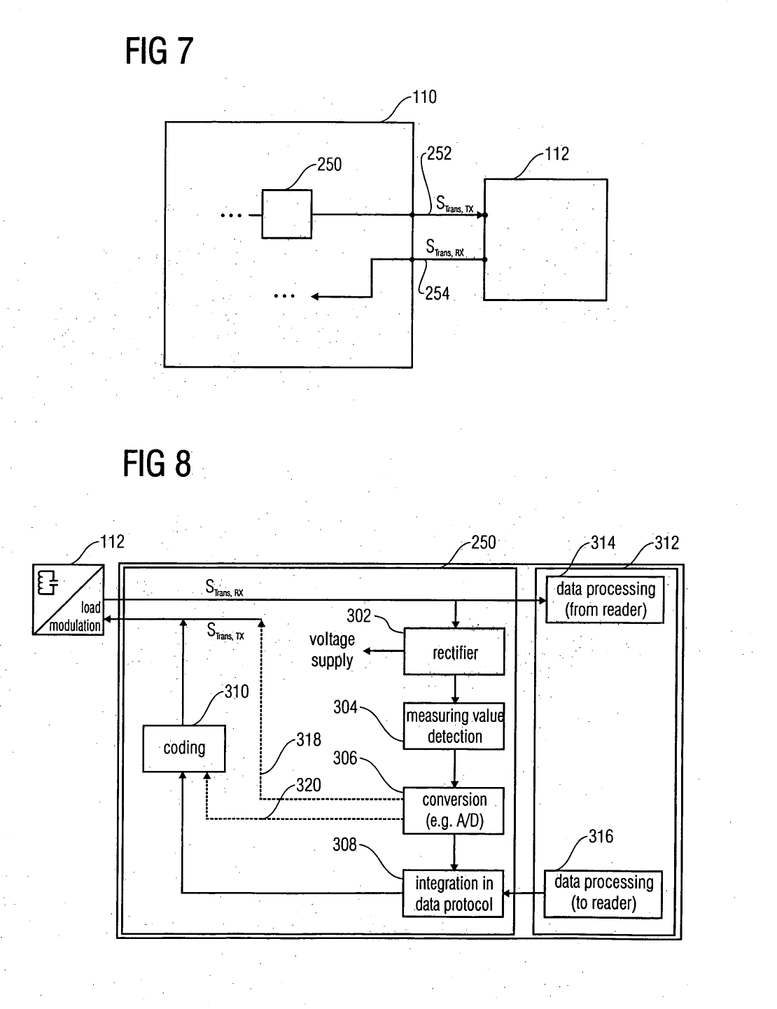

FIG. 7 is a schematic illustration of a transponder having antenna means according to an embodiment of the present invention;

FIG. 8 shows a block circuit diagram of a passive transponder according to an embodiment of the present invention;

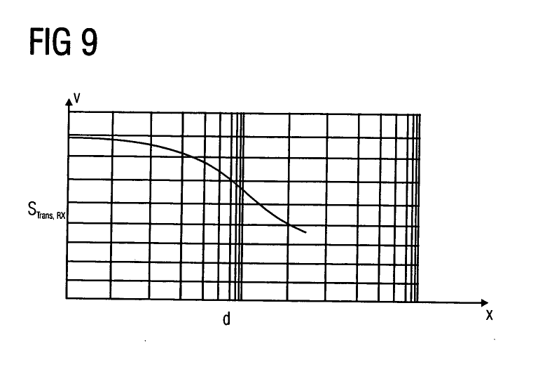

FIG. 9 is an exemplary illustration of an induction voltage measurement at an AD converter in a transponder according to an embodiment of the present invention plotted against a distance from the transponder to a transceiver;

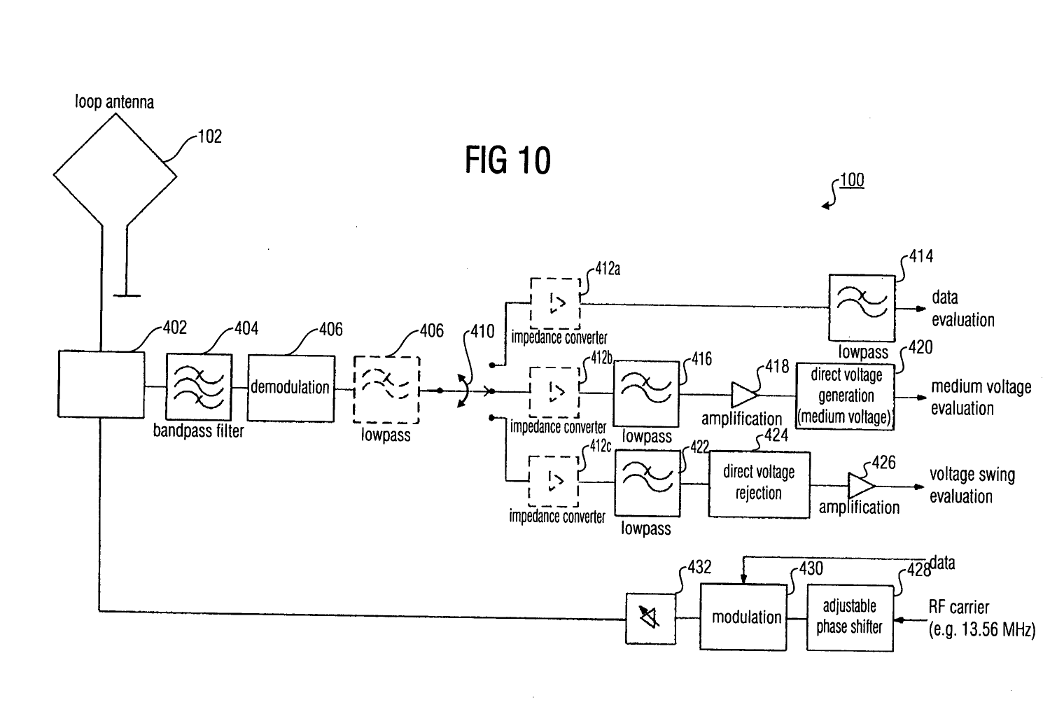

FIG. 10 shows a block circuit diagram of a modified transceiver according to an embodiment of the present invention;

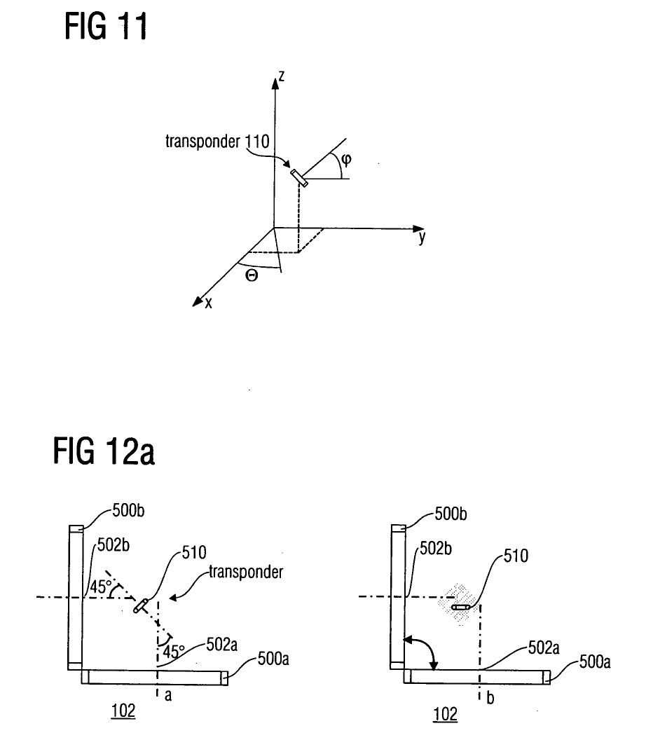

FIG. 11 is a schematic illustration of a transponder in the 3-dimensional space;

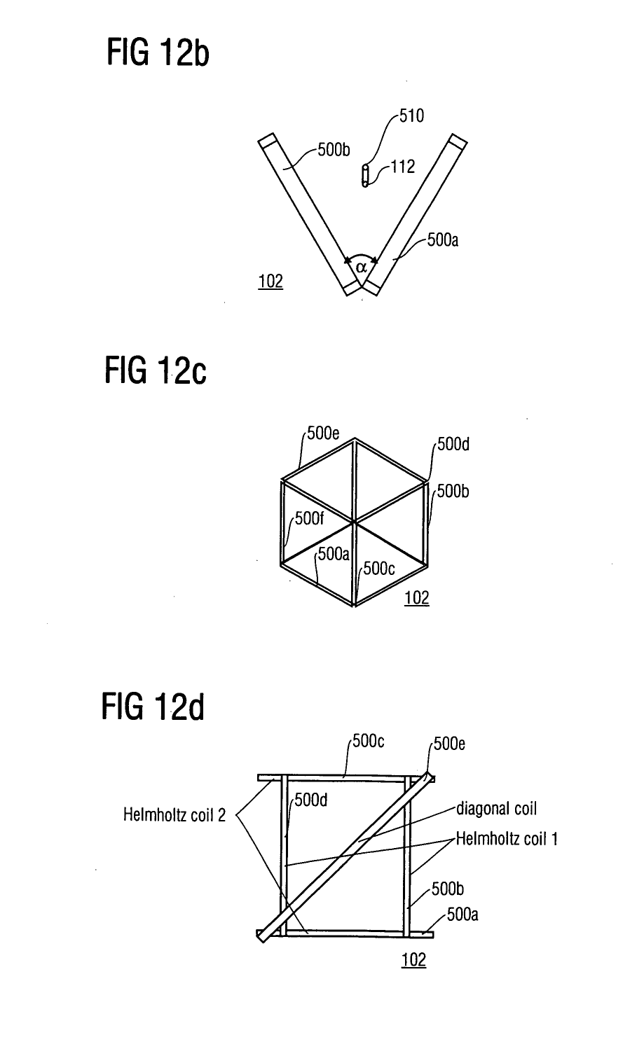

FIG. 12a is a schematic illustration of orthogonally disposed coils as antennas according to the present invention;

FIG. 12b is a schematic illustration of coils arranged at arbitrary angles as antennas according to the present invention;

FIG. 12c is a schematic illustration of antenna means including six orthogonally arranged coils as antennas according to the present invention;

FIG. 12d shows an antenna arrangement including two mutually orthogonal Helmholtz coil pairs and a diagonal coil according to the present invention;

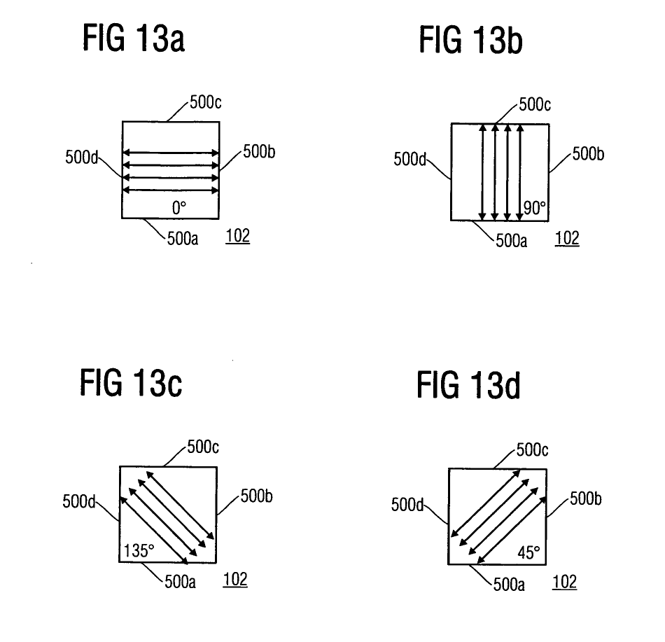

FIG. 13a shows an antenna arrangement including four rectangularly arranged coils for producing a magnetic field orientation of 0° according to the present invention;

FIG. 13b shows an antenna arrangement including four rectangularly arranged coils for producing a magnetic field orientation of 90° according to the present invention;

FIG. 13c shows an antenna arrangement including four rectangularly arranged coils for producing a magnetic field orientation of 135° according to the present invention;

FIG. 13d shows an antenna arrangement including four rectangularly arranged coils for producing a magnetic field orientation of 45° according to the present invention;

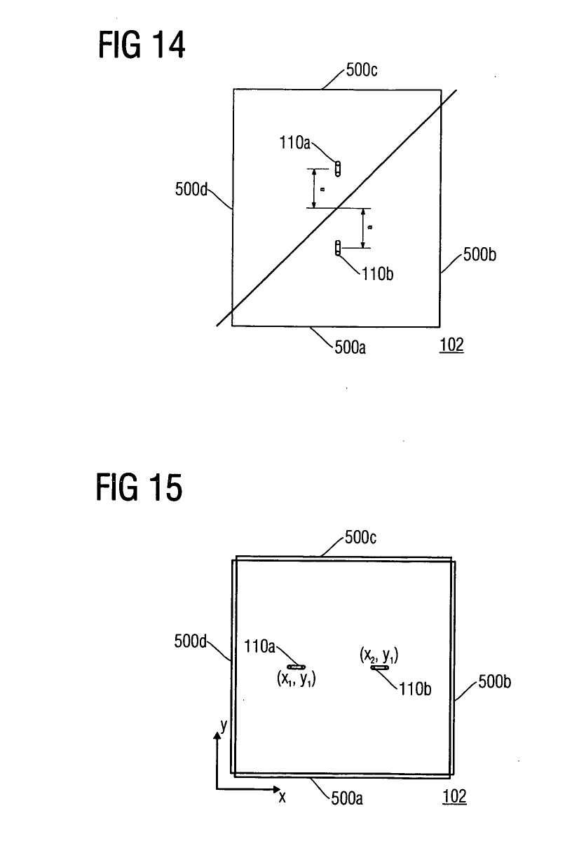

FIG. 14 shows an antenna arrangement including two mutually orthogonal Helmholtz coil pairs and a diagonal coil and two transponders according to the present invention;

FIG. 15 shows an antenna arrangement including four rectangularly arranged antennas and a transponder having two possible positions according to the present invention;

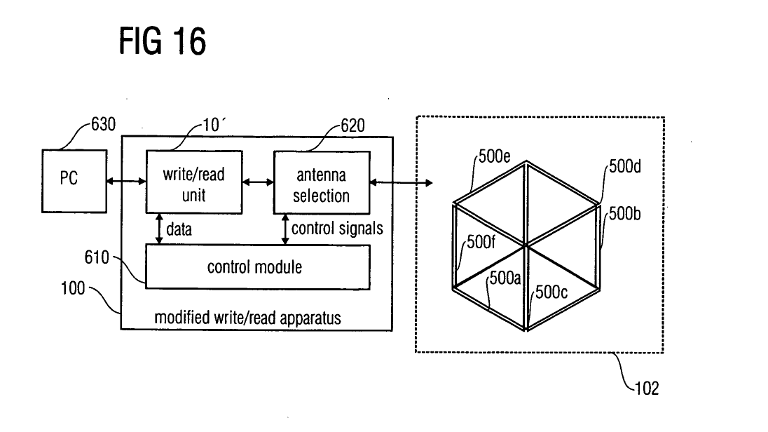

FIG. 16 shows a block circuit diagram of a transceiver according to an embodiment of the present invention coupled to antenna means having six orthogonally arranged coils as antennas according to the present invention;

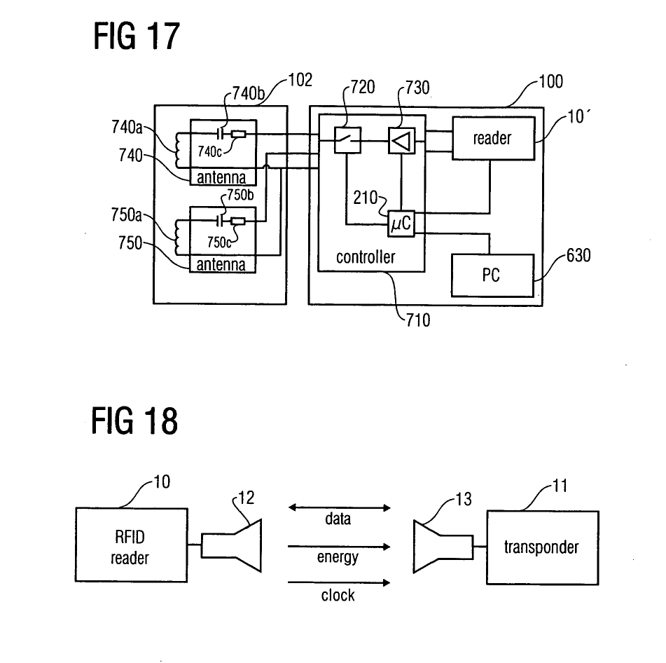

FIG. 17 shows a block circuit diagram of a transceiver according to an embodiment of the present invention coupled to antenna means having two antenna elements according to the present invention; and

FIG. 18 shows a typical setup of a conventional RFID system.

With regard to the subsequent description, it should be noted that in the different embodiments same functional elements or functional elements having the same effect have the same reference numerals and thus the descriptions of these functional elements in the different embodiments illustrated below are interchangeable.

Subsequently, the term “signal” is used for both currents and voltages, except where indicated otherwise.

FIG. 1 shows an exemplary setup of an RFID system. Such a system includes at least a reader or transceiver 100 and a transponder 110. Both the reader 100 and the transponder 110 each comprise antenna means 102 and 112, respectively, in a mutual distance d. The antenna means 102 of the transceiver 100 comprises a coil having an inductivity L₁ and the antenna means 112 of the transponder 110 comprises a coil having an inductivity L₂.

A data transfer from the transponder 110 to the transceiver 100 makes use of the features of a transforming coupling effect between the coil L₁ of the antenna means 102 of the transceiver 100 and the coil L₂ of the antenna means 112 of the transponder 110, wherein the coil of the antenna means 102 of the transceiver 100 can be considered as a primary coil and the coil of the antenna means 112 of the transponder 110 can be considered as, a secondary coil of a transformer formed of the antenna means 102 and the antenna means 112.

Due to the mutual inductivity M depending on a magnetic coupling of the coils L₁, L₂, an alteration of a current I₂ through the secondary coil L₂ on the side of the transponder 110 also causes an alteration of a current I₁ or voltage U₁ at the primary coil L₁ on the side of the transceiver 100, corresponding to the principle of a transformer. The magnetic coupling of the coils in turn depends on the distance d between the coil L₁ of the antenna means 102 of the transceiver 100 and the coil L₂ of the antenna means 112 of the transponder 110. To simplify subsequent discussions, a distance between transceiver and transponder or antenna means thereof will be frequently mentioned subsequently, wherein this is to signify the antenna distance.

An alteration of the current in the secondary coil L₂ on the side of the transponder 110 also causes an alteration of the current or voltage at the primary coil L₁ on the side of the reader 100, like in a transformer. This voltage, change at the reader antenna 102 in its effect corresponds to an amplitude modulation, however usually with a very small modulation factor. By switching an additional load resistor in the transponder 110 on and off clocked with the data to be transferred, data can be sent to the reader 100. This process is referred to as load modulation. The distance d is preferably to be provided such that the transponder 110 is in the near field of the antenna of the transceiver 100 to allow communication between the transceiver 100 and the transponder 110 by inductive coupling.

According to the present invention, the connection between the magnetic coupling of the coils L₁, L₂ and their mutual distance d is utilized for the inventive procedure for determining the position of the transponder 110 by inductive coupling by producing a magnetic alternating field which may, for example, have a frequency of 125 kHz or 13.56 MHz or even another frequency suitable for RFID systems, by means of the transceiver 100 and the antenna, means 102 and determining an electrical quantity as an association signal in the transceiver 100 and/or the transponder 110, wherein the electrical quantity represents a measure of the inductive coupling between the antenna means 102 of transceiver 100 and the transponder 110, and wherein the distance d from the transponder 110 to the antenna means 102 may be associated to the inductive coupling. This electrical quantity or association signal exemplarily results from the response field strength or the read field strength of the transponder or the changes thereof, from a field strength measurement of the electrical alternating field at the transponder or from an evaluation of a load modulation caused by the transponder.

Subsequently, different specific aspects of the inventive procedure for determining the position, direction or motion of a transponder in a radio system (RFID system) by means of inductive coupling will be detail subsequently, wherein further specific embodiments and designs of the present invention will be described subsequently referring to FIGS. 2-17.

As the subsequent discussion will clarify, an electrical quantity as an association signal representing a measure of inductive coupling between the antenna means of the transceiver and the transponder in the present invention can be determined either on the side of the transceiver or on the side of the transponder. A distance from the transponder to the antenna means of the transceiver and thus from the transponder to the transceiver may be associated to the electrical quantity and thus also the inductive coupling between the antenna means of the transceiver and the antenna means of the transponder.

FIG. 2 shows an inventive transceiver 100 coupled to antenna means 102. The transceiver comprises means 104 for generating a drive signal Sₛₜ for driving the antenna means 102 via a line 106. Furthermore, the transceiver 100 comprises processing means 108 coupled to the antenna means 102 via a line 107 for processing a signal S_{Rx} resulting from the antenna means 102. In addition, optionally the drive signal Sₛₜ or an equivalent value thereof may be coupled into the processing means 108 for processing Sₛₜ, which is indicated in FIG. 2 by the broken line.

The means 104 for generating the drive signal Sₛₜ for driving the antenna means 102 may exemplarily be formed such that the drive signal Sₛₜ may be varied or such that the means 104 provides a constant drive signal Sₛₜ for the antenna means 102. The drive signal Sₛₜ may, for example, be a current for feeding the antenna means 102.

In the present embodiment of the invention, the transceiver 100 is connected to the antenna means 102 via two lines 106 and 107, wherein the line 106 carries the drive signal Sₛₜ for driving the antenna means 102 and the line 107 carries a signal S_{Rx} resulting from the antenna means 102. A separation between transmitting and receiving paths here exemplarily takes place in the antenna means 102. This separation between transmitting and receiving paths may, according to the present invention, also take place in the transceiver 100, wherein in this case it would be sufficient to connect the transceiver 100 to the antenna means 102 via one line only.

The processing means 108 for determining the association signal as a measure of the inductive coupling between the transceiver 100 and a transponder calculates a distance from the transponder to the transceiver 100 from the association signal which may exemplarily correspond to a voltage S_{Rx} at the antenna means 102, an antenna feed current Sₛₜ or digital data transferred in a transfer protocol from a transponder to the transceiver 100. Exemplarily, a microcontroller could take over the function of the means 104 and/or 108.

Subsequently, an embodiment of the present invention will be described where the association signal is calculated on the side of the transceiver.

According to an aspect of the present invention, a response field strength or read field strength of a transponder 110 may be taken as an indicator for determining the distance from the transponder to the antenna means 102 of the transceiver 100. The response field strength or response minimum field strength is that field strength where the transponder still operates just properly, i.e. the field strength is sufficient for a voltage supply of the transponder. The read field strength or read minimum field strength is the minimum field strength required for a communication between the transponder and the transceiver 100. The read minimum field strength thus is usually greater than the response minimum field strength.

If, exemplarily, a current through the antenna means 102 of the transceiver 100 is altered by the means 104 step by step, or continually, the magnitude of the magnetic field generated by the antenna means or of the magnetic alternating field at a certain location relative to the antenna means 102 will change correspondingly.

According to an embodiment of the present invention, the current through the antenna means 102 may exemplarily be controlled by means of a resistance network, as is exemplarily shown in FIG. 3.

FIG. 3 shows a resistance network which may exemplarily realize the means 104 described referring to FIG. 2 for generating the drive signal Sₛₜ for driving the antenna means 102, wherein in this embodiment according to the present invention the drive signal Sₛₜ is an antenna feed current. The resistance network 104 includes several resistors connected in parallel of which, for reasons of clarity, only two have been provided with reference numerals 202a, 202b. The resistors 202a and 202b may each be switched in by associated switches 204a, 204b into a current flow from an input 104a to an output 104b of the resistance network 104. The switch positions of the switches 204a and 204b are exemplarily controlled by a microcontroller 210.

As does the coil L₁ of the antenna means 102 of the transceiver 100, a coil L₂ of antenna means 112 of a transponder 110 includes several important features. One such feature is converting a magnetic alternating field having a certain field strength into a current and a voltage for supplying the transponder 110 with energy. According to the invention, the antenna feed current Sₛₜ and thus the magnitude of the magnetic alternating field produced may be passed from a low starting value up to a maximum value or vice versa. If a transponder 110 is within reach of the antenna means 102 of the transceiver 100, the transponder 110 will “respond” as soon as its required response minimum field strength or read minimum field strength is reached. Thus, a distance from the transponder 110 to the antenna means 102 can be associated to different antenna feed currents Sₛₜ of the transceiver 100.

If the antenna feed current Sₛₜ and thus the magnitude of the magnetic alternating field generated increases from a flow starting value, the response minimum field strength of the transponder will at first be reached starting from a first antenna feed current Sₛₜ, which the transceiver “notices” due to an abrupt change of the antenna feed current Sₛₜ or the voltage at the primary coil L₁ on the side of the transceiver 100, due to the mutual inductivity from the magnetic coupling of coils L₁ and L₂ on the side of the transponder 110. If the antenna feed current Sₛₜ and thus, the magnitude of the magnetic alternating field generated is increased further, the read minimum field strength of the transponder 110 will be reached starting from a second antenna feed current Sₛₜ, which may be recognized by the fact that a proper data communication between the transponder 110 and the transceiver 100 is possible starting from this read minimum field strength.

The response minimum field strength may, for example, be taken as an indicator for determining the distance from the transponder 110 to the antenna means 102 when there is only a single transponder within reach of the antenna means 102. If, however, a plurality of transponders are within reach, preferably the read minimum field strength should be selected as an indicator for determining the distance from the transponder 110 to the antenna means 102, since here communication between the transceiver 100 and the transponder 110 and thus a specific selection of the transponder 110 by anti-collision methods for differentiating the individual transponders is possible.

FIG. 4 shows a schematic illustration of processing means 108 according to an embodiment of the present invention utilizing the response minimum field strength of a transponder as an indicator for determining the distance from the transponder to the antenna means of the transceiver.

The processing means 108 comprises an input 108a and an output 108b. A variable antenna feed current Sₛₜ (or an equivalent signal) is fed to the input 108a. Within the processing means 108, a distance d from the transponder to the transceiver is associated according to a rule d=f(Sₛₜ) to that antenna feed current Sₛₜ where the magnetic alternating field generated by the transceiver is sufficiently great in order to generate the exact response minimum field strength required by the transponder at the position of the transponder so that a communication between the transponder and the transceiver is possible. The distance d determined in this way is provided at the output 108b of the processing means 108 for further processing. The antenna current Sₛₜ thus represents an association signal representing a measure of the inductive coupling between the antenna means of the transceiver and the transponder, wherein the distance d from the transponder to the antenna means may be associated to the inductive coupling.

If the antenna means of the transceiver includes only a single coil (1-dimensional case), only the distance d from a transponder to the antenna means can be determined via the antenna current Sₛₜ by the antenna means. If, for example, a direction of movement of the transponder is known or preset, the position of the transponder will be detectable.

If a position of the transponder in a multi-dimensional space is to be determined, the inventive method described may be extended to several antenna elements, which will be discussed in greater detail below referring to FIGS. 12a-12d, 13, 14 and 15.

Subsequently, another procedure for short-range localization according to another aspect of the present invention will be discussed referring to FIGS. 5, 6a-e, where the association signal is determined on the side of the transceiver.

According to this other aspect of the present invention, at least one of two evaluation signals generated in an input circuit or reception path of the antenna means of the transceiver by a load modulation of the transponder is determined for localizing a transponder at the transceiver. The evaluation signals determined at the transceiver thus are formed by a transforming coupling effect of the transponder to the transceiver depending on the distance from the transponder to the transceiver.

FIG. 5 shows a schematic illustration of processing means 108 according to another embodiment of the present invention utilizing a first evaluation signal S₌ and/or a second evaluation signal S_{˜} of a reception signal S_{Rx} generated in an input circuit of the antenna means of the transceiver by a load modulation of the transponder as an indicator for determining the distance from the transponder to the antenna means of the transceiver. The processing means 108 comprises an input 108a and an output 108b.

A receive signal S_{Rx}, such as, for example, a voltage, of the input circuit of the antenna means of the transceiver is at the input 108a of the processing means 108. The signal S_{Rx} can be divided into a first evaluation signal S₌ or a second evaluation signal S_{˜} (see FIG. 6a).

In addition, FIG. 6a, qualitatively and exemplarily, shows a schematic illustration of a connection between a first evaluation signal S=and a second evaluation signal S_{˜} measured at an antenna of a transceiver according to the present invention. Exemplarily, the term evaluation signals may be used for current or voltage values.

The first evaluation signal S₌ may, for example, correspond to a so-called medium voltage. The medium voltage S₌ thus corresponds to a direct voltage portion which is superimposed on the receive signal S_{Rx} after demodulation and exemplarily not separated by a coupling capacitor in an inventive transceiver 100, but evaluated explicitly. As has already been discussed, the coil L₁ of the reader antenna 102 and the coil L₂ of the transponder antenna 112 are coupled to each other in a transforming manner. Thus, the coil L₁ of the reader 100 represents the primary coil and the coil L₂ of the transponder 110 represents the secondary coil of a transformer. If a transformer is loaded on the secondary side, a secondary current (at the transponder, 110) will cause an additional magnetic alternating field. According to the law by Lenz, the magnetic field change caused by the secondary current is opposite in direction to that caused by the primary current (at the transceiver 100). The effective magnetic field change, when loaded, in the primary coil L₁ of the reader antenna 102 is smaller than in an unloaded case, i.e. if there is no transponder 110. Thus, the voltage induced at the primary coil L₁ of the reader 100 is smaller. Since the medium voltage S=corresponds to that voltage resulting from rectifying the voltage S_{Rx} at the primary coil L₁, the medium voltage S₌ is also becoming smaller with secondary-side loading by a transponder 110.

If an inductive coupling factor κ of the primary and secondary coils is decreased, i.e. the distance between the transponder 110 and the reader 100 is increased, the medium voltage S₌ will increase correspondingly, since the coupling of the transponder 110 to the transceiver 100 becomes smaller. If the coupling factor κ is zero, the transponder 110 will be outside the response region of the reader 100 and the result will be the maximum voltage quantity of the medium voltage S₌. This connection is illustrated schematically in FIG. 6b.

FIG. 6b shows, in a semi-logarithmic illustration, a measured course of the medium voltage S₌ plotted against a logarithmically plotted distance d of the transponder 110 from the reader 100.

Correspondingly, FIG. 6c shows a schematic course of the medium voltage S₌ plotted against the coupling factor κ of the transponder 110 to the reader 100.

In the processing means 108 shown in FIG. 5, the medium voltage S₌ is exemplarily calculated and then the distance d from the transponder to the transceiver is determined according to a rule d=g₁(S₌) reciprocal to the one shown in FIG. 6b. The medium voltage S₌ accordingly represents an association signal representing a measure of an inductive coupling between the antenna means 102 of the transceiver 100 and the transponder 110, wherein a distance d from the transponder 110 to the antenna means 102 of the transceiver 100 may be associated to the inductive coupling.

This procedure for short-range localization will also work without data being transferred from the transponder. However, it should be kept in mind that in a plurality of transponders in the magnetic alternating field of the reader 100 the medium-voltage S₌ measured at the reader 100 may be interpreted as a coupling of the plurality of transponders. By using suitable anti-collision methods, however, inductive coupling of more transponders than the transponder to be localized may be avoided by, for example, separating the antenna resonant circuits of the transponders not to be localized for a certain period, i.e. idling, to be able to specifically determine an inductive coupling and thus a distance of the transponder to be localized. Furthermore, a differentiation of the plurality of transponders by different resonant frequencies of the transponder antennas is, for example, conceivable.

In addition, an improvement may, for example, be achieved by a combination of the medium voltage S₌ and the second evaluation signal S_{˜}.

The second evaluation signal S_{˜} may, for example, correspond to a so-called voltage swing. The determination of the voltage swing S_{˜} is another possibility of determining the position of a transponder 110, which in turn may, for example, be used for determining motion. The voltage swing S_{˜} results when a carrier signal of the transceiver 100 at the antenna resonant circuit of the transceiver 100 is loaded by the transponder 110 in the rhythm of the data and thus a kind of amplitude modulation of the carrier is caused. An inventive transceiver 100 may then evaluate the quantity of this voltage swing to obtain a distance d from this. In this inventive method for determining the position, the quantity of the voltage swing S_{˜} is measured in the processing means 108. The voltage swing S_{˜} is linked to the input circuit of the reader 100 via the load modulation of the transponder 110 and thus is also related to the distance d from the transponder 110 to the reader 100 by the inductive coupling factor κ. The dependence, however, is reversed compared to the medium voltage S₌. The closer a transponder 110 to the reader 100, the stronger the effects of the load modulation, and thus the voltage swing S_{˜} increases.

FIG. 6d shows, in a semi-logarithmic illustration, a measured course of a voltage swing S_{˜} plotted against a logarithmically illustrated distance d of the transponder 110 from the reader 100. Correspondingly, FIG. 6e shows a schematic course of the voltage swing S_{˜} plotted against the coupling factor κ of the transponder 110 to the reader 100. The connection between the voltage swing S_{˜}, the distance d and the coupling factor κ will become obvious from the course of the graphs illustrated in FIGS. 6d and 6e.

In the processing means 108 shown in FIG. 5, the quantity of the voltage swing S_{˜}, for example, is determined and thus the distance d from the transponder 110 to the transceiver 100 is determined by means of a rule d=g₂(S_{˜}) reciprocal to the one shown in FIG. 6d. The voltage swing S_{˜} thus represents an association signal representing a measure of inductive coupling between the antenna means of the transceiver and the transponder, wherein a distance from the transponder to the antenna means may be associated to the inductive coupling.

The distance d determined by the medium voltage and/or the voltage swing is provided at the output 108b of the processing means 108 for further processing.

If the measurement is performed only for one antenna, only a one-dimensional distance determination may be performed, like in the inventive procedure for a short-range position determination described before. For the case that, for example, a multi-dimensional detection is required and the transponders exemplarily are in different angular relations to the reading antenna or are moving, principles having several antennas will be discussed subsequently.

Subsequently, another inventive procedure for short-range position determination according to another embodiment of the present invention will be discussed referring to FIGS. 7-9, wherein the association signal in this embodiment is determined on the side of the transponder.

According to this further aspect of the present invention, localization or short-range position determination of a transponder may be obtained by detecting and, for example, rectifying and smoothing a voltage induced by the magnetic field generated by the transceiver 100, in the transponder 110, at a resonant circuit of antenna means 112 of a transponder 110 so that a direct voltage value corresponding to the voltage induced is the result. This direct current value is, for example, converted to a corresponding digital value by an analog-to-digital converter and then integrated and transferred as data in a corresponding data transfer protocol between the transponder and the transceiver. The voltage induced by the magnetic field could be digitalized and processed in a transponder having correspondingly powerful signal processing, exemplarily even directly, i.e. without rectifying and smoothing. The transceiver may then preferably filter out the digital field strength data integrated in the transfer protocol from the actual useful data of the communication so that they are available for evaluation, exemplarily by means of a PC. The digital data transferred in this way here is preferably proportional to the field strength of the magnetic field at the transponder, which in turn is a measure of the distance from the transponder to the transceiver.

FIG. 7 shows a schematic illustration of an inventive transponder 110 coupled to antenna means 112. The transponder 110 comprises means 250 for providing an association signal S_{Trans,Tx} representing a measure of inductive coupling, wherein the means 250 is coupled to the antenna means 112 via a line 252. In addition, the transponder 110 is coupled to the antenna means 112 via another line 254 carrying a signal S_{Trans,Rx} resulting from the antenna means 112.

The means 250 for providing an association signal S_{Trans,Tx} may, for example, be formed such that a voltage induced by the magnetic field (magnetic alternating field) generated by a transceiver 100 in the means 250 is rectified and smoothed at a resonant circuit of the antenna means 112 of the transponder 110 so that there is a direct voltage value corresponding to the voltage induced. This direct voltage value is, for example, converted to a corresponding digital value by an analog-to-digital converter and then provided as data for a corresponding data transfer protocol for a communication between the transponder 110 and the transceiver 100 (not shown in FIG. 7).

In the present embodiment of the invention, the transponder 110 is connected to the antenna means 112 via two lines 252 and 254, wherein the line 252 carries the association signal S_{Trans,Tx} and the line 254 carries a signal S_{Trans,Rx} resulting from the antenna means 112. Thus, a separation between the transmitting and receiving paths here exemplarily takes place in the antenna means 112. This separation between transmitting and receiving paths may, however, according to the present invention equally take place in the transponder 110, wherein then it would be sufficient to connect the transponder 110 to the antenna means 112 via only one line.

FIG. 8 shows another possible technical realization of a passive transponder 110 according to an embodiment of the present invention comprising the antenna means 112 in the form of a block circuit diagram. In addition, the transponder 110 comprises means 250 for providing the association signal S_{Trans,Tx} including a rectifier 302, means for analog measuring value detection 304, an A/D converter 306, means 308 for integrating the digital data generated by the A/D converter 306 into a data protocol and means 310 for coding the data determined for the transceiver. The transponder 110 additionally comprises processing means 312 including both means 314 for processing data, sent by a transceiver 100, and means 316 for transferring data to a transceiver 100, exemplarily by means of load modulation.

The antenna means 112 of the transponder 110 usually includes a parallel resonant circuit including a coil and a capacitor. Thus, the coil may, for example, be formed as a frame or ferrite rod antenna. The magnetic alternating field generated by a transducer induces a voltage in the transponder coil. Since the magnetic field strength generated by the transceiver 100 is a function of the distance of the transponder 110 from the transceiver 100, the distance of the transponder 110 from the transceiver 100 may be calculated back in the transponder 110 by measuring the induction voltage by means of the means for measuring value detection 304.

Using the transponder 110 illustrated in FIG. 8, the determination of the association signal S_{Trans,Tx} is, for example, performed according to the following principle the analog voltage S_{Trans,Rx} induced at the antenna means 112 is rectified and smoothed by the rectifier 302 so that there is a direct voltage value corresponding to the voltage induced which may exemplarily also be used for a voltage supply of the transponder 110. This direct voltage value is measured by measuring value detection means 304 and digitalized by an A/D converter 306. This digital data corresponding to the direct voltage value may then be integrated by the means 308 for integrating the digital data in a data transfer protocol between the transponder 110 and the transceiver 100 and transferred from the transponder 110 to the transceiver 100.

The transceiver or reader 100 may be formed to filter out, after the transfer, the digital direct voltage values integrated in the data protocol as a measure of the field strength of the magnetic alternating field at the transponder 110 from the actual useful data so that they are available for evaluation, exemplarily in a PC. The digital data transferred in this way thus depends on the field strength of the magnetic alternating field at the transponder 110. If this data is, for example, compared to calibrating data of an initial field determined before, where the field strength is known at any point, the distance from the transponder 110 to the reader antenna 102 may also be determined here. Correction values or correction factors may also be considered here. A correction value exemplarily considers the influence of the magnetic alternating field by integrating a transponder and/or an object where the transponder is mounted in the magnetic alternating field (measuring field), which is how, for example, the field strength at the location of the transponder is changed. Correction values or correction factors may also be used for considering any influences to the magnetic alternating field. The direct voltage values determined in the transponder 110 thus represent an association signal representing a measure of the inductive coupling between the antenna means of the transceiver and the transponder, wherein a distance from the transponder to the antenna means may be associated to the inductive coupling.

Optionally, the voltage S_{Trans,Rx} induced by the magnetic alternating field at the antenna means 112 could also be digitalized directly without rectifying and transferred by means of load modulation from the transponder 110 to the transceiver 100. However, the result would be a considerably greater amount of data to be transferred from the transponder 110 to the transceiver 100 to result and to be handled.

Furthermore, it is optionally also conceivable that the digital data corresponding to the direct voltage value not to be integrated in a data transfer protocol between the transponder 110 and the transceiver 100 but exemplarily transferred directly in an uncoded or coded manner by means of load modulation from the transponder 110 to the transceiver 100, as is indicated in FIG. 8 by the broken signal paths 318 and 320.

Data processing for determining the position of the transponder could also take place in the transponder itself, given corresponding performance, wherein in this case the location determined by the transponder could, for example, be transferred from the transponder to the transceiver.

FIG. 9 shows an exemplary illustration of a measurement of an induction voltage S_{Trans,Rx} at an AD converter in a transponder according to an embodiment of the present invention plotted against a distance d from the transponder to a transceiver illustrated in a logarithmic scale.

The voltage S_{Trans,Rx} induced at a transponder coil 112 is a measure of the field strength of the magnetic alternating field at the location of the transponder 110. The field strength of the magnetic alternating field in turn may be associated to the distance from the transponder 110 to the transceiver. As can be seen from FIG. 9, the field strength of the magnetic alternating field at the location of the transponder 110 and thus the induction voltage S_{Trans,Rx} induced, too, decreases with an increasing distance from the transponder to the reader. Since every voltage value of the voltage S_{Trans,Rx} induced may be associated precisely to a distance value d, the corresponding distance value d may directly be determined from a voltage value. Direct voltage values determined in the transponder 110 also represent an association signal representing a measure of the inductive coupling between the antenna means 102 of the transceiver 100 and the transponder 110, wherein a distance d from the transponder 110 to the antenna means 102 may be associated to the inductive coupling.

FIG. 10 shows a principle block circuit diagram of an exemplary technical realization of a transceiver for the inventive procedures for short-range localization of a transponder by inductive coupling described before. FIG. 10 only represents signal paths, control signals remaining unconsidered.

FIG. 10 shows a loop antenna 102 forming an antenna input or antenna output resonant circuit with an RF front-end circuit 402. The resonant circuit including the antenna 102 and the front-end circuit 402 which in the easiest case is realized by a capacitor is connected to a bandpass filter 404. The output of the bandpass filter 404 is connected to a demodulator 406 to the output of which a low-pass filter 408 may be coupled. Switching means 410 is located at the output of the demodulator 406 or the optional low-pass filter 408 to be able to switch between different optional signal branches A, B and C, each corresponding to one of the inventive procedures for short-range localization of inductively coupled transponders described before. With reference to FIG. 10, it should also become clear that, when realizing an inventive transceiver, optionally only one of the signal paths A-C, two of the signal paths A-C or, all signal paths A-C could of course also be provided.

The first signal branch A comprises an optional impedance converter 412a and a low-pass filter 414 connected thereto or only the low-pass filter 414. The second signal path B comprises an optional impedance converter 412b, a low-pass filter 416, a downstream amplifier 418 and a circuit 420 connected to the amplifier for generating a direct voltage (so-called medium voltage). The third signal path C comprises an optional impedance converter 412c, a low-pass filter 422, followed by a circuit for suppressing a direct voltage 424 and an amplifier 426.

In order to transmit data, a transmit signal path D to the antenna 102 exemplarily includes an adjustable phase shifter 428, a modulator 430 and a controllable amplifier 432.

The first signal branch A with the optional impedance converter 412a and the low-pass filter 414 connected thereto exemplarily serves to evaluate data of a transponder, wherein the data in the transponder 110 may contain direct voltage values determined as an association signal representing a measure of the inductive coupling between the antenna means 102 of the transceiver and the transponder 110, wherein a distance from the transponder 110 to the antenna means 102 may be associated to the inductive coupling. Equally, data of a transponder 110 may also be evaluated via this first signal path A, responding as soon as its required response minimum field strength or read minimum field strength has been reached. As is described above, the response minimum field strength or read minimum field strength of the transponder 110 serves as an indicator for determining the distance to the antenna 102 of the reader.

The second signal path B with the optional impedance converter 412b, the low-pass filter 416, the downstream amplifier 418 and the circuit 420 for generating a direct voltage connected to the amplifier 418 exemplarily serves for evaluating the medium voltage S₌ described before as an association signal representing a measure of the inductive coupling between the antenna means 102 of the transceiver 100 and the transponder 110, wherein a distance from the transponder 110 to the antenna means 102 may be associated 110 to the inductive coupling.

The third signal path C comprises the optional impedance converter 412c, the low-pass filter 422, followed by the circuit for suppressing a direct voltage 424 and the amplifier 426. Exemplarily it serves for evaluating the voltage swing S_{˜} described before as an association signal representing a measure of the inductive coupling between the antenna means 102 of the transceiver 100 and the transponder 110, wherein a distance from the transponder 110 to the antenna means 102 may be associated to the inductive coupling.

The transmit signal path D includes the adjustable phase shifter 428 by which a phase of a high-frequency carrier signal may be varied. The phase shifter 428 is connected to the modulator 430 to modulate the data to be transmitted onto the high-frequency carrier. Finally, a controllable amplifier 432 is connected between the antenna resonant circuit 400, 402 and the modulator 430 to be able to vary, for example, a current as a drive signal Sₛₜ for the antenna 102.

The circuit arrangement illustrated in FIG. 10 for a transceiver 100 may thus be used for all the procedures for determining the position of an inductively coupled transponder described before.

So far, the description of the inventive methods and devices for determining the position of inductively coupled transponders have generally discussed antenna means 102 on the side of the transceiver 100. In a simplest case, the antenna means 102 only includes one single antenna. Only a one-dimensional positional determination or distance determination from the antenna may be performed with a single reader antenna, as has been described before, i.e. only a distance from the transponder to the reader antenna can be determined. If, for example, a direction of movement of the transponder is known, a position in a multi-dimensional space may nevertheless be determined. If the direction of movement is not known or if the transponder does not move, at least two antennas will be necessary to perform a positional determination in the 2-dimensional space. At least three antennas are correspondingly required to determine a position of the transponder in the 3-dimensional space, in case the direction of movement of the transponder is not preset or known.

Possible realizations and designs of antennas or antenna patterns which may inventively be employed for short-range localization of inductively coupled transponders to realize the antenna means 102 will be discussed subsequently referring to FIGS. 11-16.

FIG. 11 shows a schematic illustration of a transponder 110 in the 3-dimensional space spanned by axes x, y and z.

Thus, the transponder comprises an orientation in the 3-dimensional space defined by angles θ and φ, θ indicating the angle to the x-z plane and φ indicating the angle to the x-y plane.

Fundamentally, the position of an object in a space may be described using three space coordinates (x, y, z). If a statement is additionally to be made about the orientation of the object, generally three solid angles should additionally be known. In the case of an RFID transponder, the number of solid angles to be determined is reduced to two when it is assumed that the rotation of the transponder around its own axis does not provide a contribution due to the rotational symmetry. Due to a directional characteristic of a transponder antenna, a description of % the position of the transponder without knowing the solid angles θ and φ is not possible.

In previous descriptions of the inventive procedures for short-range localization of inductively coupled transponders, the considerations with regard to a communication range between the reader and the transponder were made under the prerequisite that the transponder antenna and the antenna of the reader be preferably aligned to each other such that the maximum possible inductive coupling between the antennas is ensured. This ideal case for inductive coupling, however, will only apply if both antenna coils or coil opening areas are arranged in parallel to each other, i.e. the middle axes of the coils are basically identical or coincide. The coil middle axis forms a normal to the coil opening areas which the magnetic alternating field flows through.

If, however, the coils or coil opening areas of the transponder and transceiver are perpendicular to each other, the inductive coupling will vanish and a communication between the transceiver and the transponder is not longer possible. In a general case, there is, on the one hand, an angle greater than 0° between the coil middle axes of the transponder and the transceiver, on the other hand, the coils are not on the same axis but are shifter with regard to each other. Due to the inhomogeneity of the coil field, the results are different angular constellations for minimum and maximum inductive coupling.

The dependence of the inductive coupling factor on the transponder orientation should preferably be considered when orienting the reader antennas when being applied for determining a position. For the case that the transponder orientation is constant, the inductive coupling factor can be adjusted corresponding to the field orientation of the read field. In the two-dimensional case with the two solid angles θ and φ, with an unknown transponder orientation, two unknown coordinates are added to the also unknown coordinates of the transponder.

Referring to FIGS. 12a to 12d, inventive procedures and antenna constellations are to be described subsequently to allow, for example, both determining an orientation and detecting a multi-dimensional position of an inductively coupled transponder.

One at least approximately orthogonal arrangement of reader antennas may preferably be provided for determining the coordinates of a transponder in the Cartesian coordinate system, as is illustrated in FIG. 12a.

FIG. 12a shows two top views of antenna means 102 having two at least approximately mutually orthogonal coils 550a, 500b, the middle axes 502a and 502b of which are perpendicular. That means the two coil opening areas are arranged in an angle in a range of 90°. In addition, FIG. 12a shows a top view of a transponder coil 510 having a coil axis 512 forming a fixed angle with each of the two coil middle axes 502a and 502b.

Preferred values for angles between two coil opening areas of antenna means are, exemplarily, in a range of 90°±15°.

In the at least approximately orthogonal arrangement of the two reader antennas 500a and 500b illustrated in FIG. 12a, the coil axis 512 of the transponder coil 510 would have to be rotated by 45° to each of the two orthogonal coil middle axes 502a and 502b to have the same receiving features for both antennas 500a and 500b (see left part of FIG. 12a).

By the dependence described before of the inductive coupling factor on the transponder orientation to the antennas of a transceiver, the result could be arrangements where a positional determination of the transponder is not possible. This is, for example, the case when the transponder coil 510 is parallel to an antenna coil 500a, and thus orthogonal to the second antenna coil 500b of the transceiver (see right part of FIG. 12a). Thus, the inductive coupling of the transponder coil 510 is maximal with regard to the first antenna coil 500a and, at the same time, minimal with regard to the second antenna coil 500b or coupling vanishes. This constellation between the antenna coils 500a, b changes depending on the position and angle of the transponder coil 510.

To solve this problem, one or several additional antennas can be mounted in an angle of, for example, 45° to the existing orthogonal antenna system of the transceiver (diagonal antenna). This can ensure that a sufficient number of antennas are available for determining the distance and, thus, position of the transponder, independently of angle and position.

FIG. 12b shows a top view of antenna means 102 having two coils 500a and 500b, the coil opening areas of which are arranged in an angle α in a range of 60°. In addition, FIG. 12b shows a top view of a transponder coil 510.

Preferred values for angles between two coil opening areas of antenna means exemplarily are in a range of 60°+15°.

The resulting triangle also ensures a positional determination, even with unfavorable transponder arrangements. According to this possible design in FIG. 12b, the two antenna coils 500a and 500b are not arranged in a 90° angle but, exemplarily, in a 60° angle to each other. Thus, the transponder coil 510 is only tilted by 30° to the antenna coils 500a, b. Thus, on the one hand, a region becomes smaller by the fact that a position of the transponder coil 510 and thus of the transponder can be determined, on the other hand, however, due to the smaller tilting the voltage induced at the transponder is greater and thus the range of an RFID system having this antenna arrangement is greater.

When the at least approximately orthogonal arrangement of the antennas of the transceiver illustrated in FIG. 12a is expanded to three dimensions, three or more antenna coils which exemplarily span three sides of a cube are required. An antenna constellation where all six sides of a cube are used for placing the antenna is illustrated in FIG. 12c.

FIG. 12c schematically shows antenna means 102 having six antenna coils 500a-f, each forming a side of an (imaginary) cube. Apart from a temporal sequential antenna drive of the individual antennas 500a-f to determine a position of a transponder within the space surrounded by the coils 500a-f, Helmholtz coil pairs may, for example, be formed by opposite coils (e.g. 500c and 500d). Furthermore, all antennas 500a-f could be driven simultaneously by drive signals having certain phase relations to one another and thus, among other things, realize the procedures for determining an orientation and for excluding ambiguities when determining the position described below.

In addition to the three or six antennas 500a-f, the antenna means 102 may additionally exemplarily be supplemented by an additional diagonal antenna, wherein constellations of this kind will be discussed in greater detail below.

In a simple three-dimensional temporally sequential driving of the antennas 500a-f by control means, the three antennas not required could, for example, also be used for difference or control measurements (plausibility checks).

For the antenna arrangements described referring to FIGS. 12a to 12c, graphs having equal measuring values, i.e. distances from a transponder to the individual antennas, may be constructed and the position of a transponder in the multi-dimensional space may be determined from intersections of the graphs of the individual antennas (triangulation). The methods required for evaluating the measured data correspond to the methods described before referring to FIGS. 1 to 10 which are here correspondingly extended to several dimensions. The association signals measured or determined in this process are, for example, compared to initial measurements which may be adjusted correspondingly by correction factors. A correction factor exemplarily considers the influence of the antenna field by introducing a transponder into the field, which is how the field strength at the position of the transponder is changed. Furthermore, correction factors may serve to correct a non-linear characteristic of the antenna field. In particular in methods selectively controlling the power of the antennas, the direction of the field lines changes depending on the antenna current. Also, a directional characteristic of the transponder may be corrected which usually deviates from an ideal description. Determining the correction data or correction factors may thus be performed in different manners, exemplarily by measurements, simulations, etc. The position of all methods thus depends, among other things, on a granularity (spatial resolution) of the initial measurements for the points measured (location coordinates), the correction factors and, maybe, on the number of allowed orientations of a transponder (angular relations). If the measurements of the association signals are performed not only once for each antenna but if these measurements or transfers are repeated continually, a movement of a transponder within the volume spanned by the antennas may exemplarily be described. If ambiguities result from evaluating different antennas, procedures described subsequently may contribute to reducing or excluding these ambiguities.

Adding the transponder angle, i.e. the positioning of the coil middle axis of the transponder, cannot simply be realized by means of further antennas. Due to the strong directional characteristic of the transponder coil, the resulting problems for determining the angle of the coil middle axis must additionally be considered. An inventive approach is using special antenna constellations, such as, for example, Helmholtz coils, for estimating the transponder angle.

FIG. 12d shows a top view of exemplary antenna means 102 having five antenna coils 500a-e, of which four antenna coils 500a-d are arranged in the shape of a rectangle or square. An antenna coil 500e forms a diagonal coil running diagonally in the square formed by the antenna coils 500a-d.

Apart from a temporally sequential antenna drive of the individual antennas 500a-e for determining a position of a transponder within the planes surrounded by the coils 500a-e, a transponder angle can also be determined using the antenna arrangement shown in FIG. 12d. Helmholtz coil pairs are formed by opposite coils 500a,c and 500b,d. A Helmholtz coil includes two coils (500a,c or 500b,d) arranged in parallel in a defined distance (exemplarily, the distance is smaller than the radius of the coils). Thus, the distance of the coils 500a,c or 500b,d is to be selected such that a magnetic field between the two coils 500a,c or 500b,d is as homogenous as possible. The sense of winding of the coils 500a,c or 500b,d is usually the same, wherein this convention with regard to the sense of winding in the case of an alternating field only applies to an in-phase drive of the antenna coils. If the coils 500a,c or 500b,d are driven as Helmholtz coils, it will not longer be possible due to the homogeneity of the field between the coils 500a,c or 500b,d to determine a distance of the transponder from one of the two coils 500a,c or 500b,d of the Helmholtz coils using the procedures described before referring to FIGS. 1 to 10. However, the transponder angle estimation principle may be employed. As soon as the transponder rotates from the ideal position oriented in parallel to the reader coils 500a,c or 500b,d, a reaction thereto may be evaluated depending on the method for short-range localization.

In the inventive method where a response minimum field strength of the transponder 110 is used as an indicator for determining the distance from the transponder 110 to the antenna means 102 of the transceiver 100, less energy is available for the transponder 110 when turning since the induction voltage decreases due to the smaller magnetic flow through the coil-opening area of the transponder coil. The field strength it requires for responding thus is no longer reached starting from a certain threshold or a certain angle. This change may be measured using the control of the antenna current by the Helmholtz coil of the antenna means 102. The transponder angle may thus be estimated up to a rotation of about 45°. Starting at 45°, reception is no longer possible since the transponder is rotated too much from the field orientation of the Helmholtz coil including the coils 500a,c or 500b,d. If, however, a second Helmholtz coil including 500b,d or 500a,c which is rotated by at least about 90° relative to the first Helmholtz coil including 500a,c or 500b,d is employed, the missing angle range can also be covered. Inventively, a rectangular system having two Helmholtz arrangements can be realized to ensure an optimum utilization of the antenna ranges in this way.

In the inventive method where an analog voltage induced by the magnetic field generated by the transceiver 100 is exemplarily rectified and smoothed at an input circuit of antenna means 112 of the transponder 110, so that the result is a direct voltage portion corresponding to the voltage induced, reduced field strengths are measured in the transponder 110 and transferred to the reader 100 due to the rotation of the transponder 110. Thus, a directional determination is possible with a temporally sequential evaluation of two Helmholtz arrangements, arranged in at least, approximately 90° angles, of the antenna means 102 of the transceiver 100.

A defined maximum range for a communication between the transceiver 100 and the transponder 110 is obtained with the antennas 500a-e employed, as is illustrated in FIG. 12d. Due to this limited range and directional characteristic of the transponder coil, in the normal case signals are obtained only from a part of the antennas 500a-e. For this reason, a differentiation of cases should preferably be performed depending on which antennas of the antenna means 102 of the transceiver 100 provide signals to then adjust an algorithm for determining the position and angle of the transponder 110 correspondingly. In the subsequent table, different constellations are exemplarily illustrated, wherein it is assumed that correspondingly at least one of the antennas 500a-e (individual antennas+Helmholtz connection) provides a signal per direction. The antennas 500a and 500c shown in FIG. 12d each form horizontal antennas and, together, a vertical Helmholtz coil. The antennas 500b and 500d each form vertical antennas and, together, a horizontal Helmholtz coil. The antenna 500e forms the diagonal antenna.

| Case | Horizontal | Vertical | Diagonal | Position determination |
|---|---|---|---|---|
| 1 | — | — | — | Not possible |
| 2 | — | — | X | Not possible |
| 3 | — | X | — | Possible to a limited extent |
| 4 | — | X | X | Possible |
| 5 | X | — | — | Possible to a limited extent |
| 6 | X | — | X | Possible |
| 7 | X | X | — | Possible |
| 8 | X | X | X | Possible |

Case 1 will arise if there is no transponder in the field of the antennas 500a-e or no functioning transponder. Case 2 essentially does not provide useful information due to the mirror symmetry of the diagonal antenna 500e, even if a previous transponder position is available. This measuring value determined before, however, may be used in cases 3 and 5. Assuming that the other parameters remain constant, the measuring value given by the association signal is considered in the positional change. Inevitably, imprecision results since slight changes of the quantities assumed to be constant may add up to form considerable errors. The desirable cases are cases 4, 6, 7 and 8 since here at least two antenna signals are available so that a two-dimensional position can be calculated. The angular position of the transponder 110 is estimated by means of the results of the Helmholtz coils 500a,c or 500b,d and the diagonal antenna 500e. Since a rotation of the transponder 110 by 180° does not influence the measuring result, the angle estimation should preferably only take place in the from 0° to 180°. In the range from 0° to 90°, the transponder 110 is in the receiving range of the diagonal antenna 500e, at angles greater than 90° this is no longer the case. A first estimation can take place in this manner. Only a precise specification of the angle by up to ±5° can be performed by means of the two Helmholtz coils 500a,c or 500b,d.

Compared to the possibility described before of sequentially driving antennas or antenna pairs, it is possible by using several antennas which are, for example, arranged rectangularly to selectively influence the orientation of the field line within the space spanned by the antennas. One might do without diagonal antennas here.

This connection is schematically illustrated in FIGS. 13a-d.

FIGS. 13a-d each show a top view of antenna means 102 having four antenna coils 500a-d arranged in the shape of a rectangle or square.

In FIG. 13a, the coils 500b,d are driven in phase, whereas the other coils are not driven such that the result is an overall magnetic field the orientation of the field lines of which takes an angle of 0°.

In FIG. 13b, the coils 500a,c are driven in phase, whereas the other coils are not driven such that the result is an overall magnetic field the orientation of the field lines of which takes an angle of 90°.

In FIG. 13c, all the coils 500a-d are driven by different phase positions such that the result is an overall magnetic field the orientation of the field lines of which takes an angle of 135°.

In FIG. 13d, all the coils 500a-d are driven by different phase positions such that the result is an overall magnetic field the orientation of the field lines of which takes an angle of 45°.

If the direction of the field lines is altered according to a certain pattern, the orientation of the transponders may be determined by evaluating the transponder reactions, i.e. the inductive coupling of the transponder.

In the case of the method for measuring the response minimum field strength or the read minimum field strength of a transponder, a first phase pattern is at first generated by means of the drive signals of the antennas 500a-d (e.g. 0°) and thus the response of the transponder 110 is measured by varying the drive signals (e.g. current) for the antenna means 102 of the reader 100. Subsequently, the measurements are repeated for other phase patterns. The orientation of the transponder 110 may be determined by evaluating the different response minimum field strengths to the different phase patterns.

In the case of the method for measuring the field strength in the transponder 110, the following is obtained by changing the orientation of the magnetic field by varying the phase positions of the antenna currents fed in the different antennas 500a-e. The voltage induced by the overall field generated in the transponder resonant circuit is measured and transferred to the reader 100 to be evaluated in the manner described before. Subsequently, another phase relation of the antenna currents fed is established and the voltage induced in the transponder resonant circuit is also measured and transferred. If at sufficient number of constellations of orientations of field lines are produced in this manner, the orientation of the transponder 110 in the space spanned by the antennas 500a-d may also be determined here by evaluating the data measured.

In the case of the method for measuring the medium voltage or voltage swing, a first phase pattern of the antenna currents fed may also at first be generated and thus the medium voltage or voltage swing at the reader 100 be evaluated. If the orientation of the field lines of the magnetic alternating field generated by the different phase relations of the antenna currents and the orientation of the transponder coil medium axis are perpendicular, the voltage swing at the reader 100 will become maximal or the medium voltage minimal. If the transponder coil medium axis and the field lines generated are parallel, the voltage swing will become minimal and the medium voltage maximal. Values in between result for different phase relations.

If the direction or orientation of the transponder has been determined by one of the procedures described before, the corresponding phase relation of the antenna feed currents may, for example, also be utilized to always supply the transponder with certain predetermined or maximally possible field strengths. Maximum field strengths will be possible if the measuring field penetrates the transponder coil approximately perpendicularly, i.e. in an angle in a range of 90°±30°. The transponder itself thus may of course have any orientation in space.

For the cases 4 and 6 of the table shown above, there is only one signal of either a horizontal antenna or a vertical antenna, and additionally the signal of the diagonal antenna. Due to the structure of the antenna arrangement illustrated in FIG. 12d, a position determination of a transponder cannot be performed in any case without considering the previous position of the transponder. This problem is illustrated in FIG. 14.

Like FIG. 12d, FIG. 14 also shows a top view of antenna means 102 having five antenna coils 500a-e, of which four antenna coils 500a-d are arranged in the shape of a rectangle or square. An antenna coil 500e forms a diagonal coil running diagonally in a square formed by the antenna coils 500a-d. In addition, FIG. 14 shows a first transponder 110a and a second transponder 110b, wherein the two transponders 110a and 110b have an equal distance a to the diagonal antenna 500e.

FIG. 14 shows two different transponder positions where identical measuring values of an association signal are expected. This results in an ambiguity of the measurement which can only be solved by considering the previous transponder positions. Here, it is sensible to determine the deviation relative to a previous measuring value and maybe to wait for additional measurements before indicating a new position.

In the methods for utilizing several pieces of temporally sequential antenna information described before, ambiguities of transponder locations can be excluded in addition to determining the orientation. If, for example, several locations were determined for a transponder due to field or symmetry features, ambiguity may be reduced or ruled but completely in the following manner referring to FIG. 15.

FIG. 15 shows a top view of antenna means 102 having four antenna coils 500a-e arranged in the shape of a rectangle or square. In addition, FIG. 15 shows a transponder 110 having a first possible location (x₁,y₁) and a second possible location (x₂,y₁).

Since it is possible by means of the methods described above to determine an orientation of the transponder 110 and thus the transponder orientation for another procedure is known, regions having different field instances may be generated by varying the phase relations of the drive signals for the antennas 500a-e of the antenna means 102 of a transceiver 100, i.e. at first a first field constellation is generated and possible locations of the transponder 110 are determined. Usually, ambiguities will result here. If subsequently the measurement is repeated with a field exemplarily oriented to the left, for example by driving the coils 500a,d, a considerably higher field strength will be available for the transponder position (x₁,y₁) than for the transponder position (x₂,y₁), i.e. if the transponder 110 is not in the position (x₁,y₁), no reaction of the transponder 110 will result despite sufficient energy supply. The transponder 110 thus is in the position (x₂,y₁) from where it cannot respond because it does not receive sufficient energy for responding. For reasons of safety, this measurement may also be reversed, i.e. exemplarily by driving the coils 500a,b, and thus the result checked. This advantage, too, of the procedure described above is inventively applicable to all methods referring to FIGS. 1 to 10.

If a movement of a transponder within the space spanned by the antennas is to be determined, this may generally take place by repeatedly determining the position according to a procedure described above. If, for example, the direction or orientation of the transponder has been determined by one of the procedures described before, the corresponding phase relations of the antenna feed currents may, based on the orientation determined, for example, be used for supplying the transponder with certain predetermined or maximally possible field strengths of the measuring field and thus be able to improve traceability of the measuring results. Subsequently, a movement of the transponder within the space spanned by the antennas can be determined by repeatedly determining the position according to one of the procedures described before. A current direction of movement of the transponder can be deduced from a combination of two successive positional measurements.

Finally, further optional transceivers according to other embodiments of the present invention of an RFID system for determining the position of a transponder by inductive coupling are to be described referring to FIGS. 16 and 17.

FIG. 16 shows an inventive realization of a transceiver 100 including a control module 610, a write/read unit 10 and antenna selection means 620 for selecting an antenna. Furthermore, the inventive transceiver 100 is coupled to a personal computer 630. In addition, the transceiver 100 for generating a magnetic alternating field is coupled to antenna means 102. In the present embodiment of the invention, the antenna means 102 includes six antenna coils 500a-f, each forming one side of a cube.

For determining the position, orientation and movement, one or several antennas of the antennas 500a-f are required depending on the number of coordinates to be determined. The distance and the orientation of a transponder from the antennas 500a-f can be determined by means of these antennas. The inventively modified write/read unit 100 thus may include one or several transmitting and receiving paths. Via the antenna selection module 620 controlled by the control module 610, either individual antennas of the antenna means 102 one after the other (sequentially) or several or all antennas 500a-f simultaneously with different phase relations can be driven by antenna feed currents via the transmit paths. In order to determine an orientation of a transponder within the space surrounded by the antennas 500a-f, Helmholtz coil pairs may be formed and driven correspondingly for example by opposite coils (e.g. 500c and 500d). One or several receive paths are available also for evaluating the signals.

FIG. 17 shows another inventive realization of a transceiver 100 comprising control means 110 including a microcontroller 210, a controllable switch 720 and a controllable amplifier 730. In addition, the transceiver 100 includes a conventional RFID write/read apparatus 10 and a personal computer 630. In addition, the transceiver 100 is coupled to antenna means 102 including two antennas 740 and 750, wherein the antennas 740 and 750 each comprise a coil 740a and 750a, respectively, a capacitor 740b and 750b, respectively, and a resistor 740c and 750c, respectively.

The RFID write/read apparatus 10 (exemplarily a conventional reader) provides an antenna current which may be varied via the microcontroller 210 and the controllable amplifier 730 of the control means 710. Additionally, the microcontroller 210 is formed to select the antennas 740 and 750 by the controllable switch 720. By means of the method described above and the PC 630, a distance to a transponder (not shown) may be determined for each of the two antennas 740 and 750 and thus finally a position of the transponder in the two-dimensional space can be calculated, as has already been described above referring to FIGS. 12a to 12d.

Transponders in a predetermined volume, for example in the order of magnitude of one or several cubic meters (m³) may be localized by the inventive methods, and devices described. Fields of application are, for example, identifying and localizing animals, such as, for example, localizing animals in the ground or localizing and identifying objects in non-accessible or difficult-to-access regions, such as, for example, chemical reaction regions. The usage of passive transponders allows the smallest setups of transponders.

In particular, it is pointed out that, depending on the circumstances, the inventive scheme may also be implemented in software. The implementation may be on a digital storage medium, in particular on a disc or a CD having control signals which may be read out electronically, which can cooperate with a programmable computer system and/or microcontroller such that the corresponding method will be executed. In general, the invention thus also is in a computer program product having a program code stored on a machine-readable carrier for performing the inventive method when the computer program product runs on a computer and/or microcontroller. Put differently, the invention may also be realized as a computer program having a program code for performing the method when the computer program runs on a computer and/or microcontroller.

1. A method for determining the position or orientation of a transponder (110) by inductive coupling in a radio system, the radio system including a transceiver (100) comprising antenna means (102), comprising the steps of:
generating a magnetic alternating field by means of the transceiver (100) and the antenna means (102); and
determining an association signal representing a measure of inductive coupling between the antenna means (102) of the transceiver (100) and the transponder (110), wherein a distance or orientation of the transponder (110) to the antenna means (102) may be associated to the inductive coupling.

2. The method according to claim 1, wherein determining the association signal takes place in the transceiver (100).

3. The method according to claims 1 or 2, wherein the transponder (110) comprises a read minimum field strength required for communication between the transponder (110) and the transceiver (100), and wherein the magnetic alternating field is generated by means of the transceiver (100) by a drive signal (S_{St}) for the antenna means (102), and wherein the step of determining the association signal comprises the following sub-steps:
varying the field strength of the magnetic alternating field via the drive signal (S_{St}); and
evaluating the drive signal (S_{St}) with regard to the communication between the transponder (110) and the transceiver (100) to determine the occurrence of the read minimum field strength of the magnetic alternating field at the transponder (110), wherein the drive-signal (S_{St}) corresponds to the association signal when the read minimum field strength occurs.

4. The method according to claims 1 or 2, wherein the transponder (110) comprises a response minimum field strength required for an energy supply of the transponder (110), and wherein the magnetic alternating field is generated by means of the transceiver (100) by a drive signal (S_{St}) for the antenna means (102), and wherein the step of determining the association signal comprises the following sub-steps:
varying the field strength of the magnetic alternating field via the drive signal (S_{St}); and
evaluating the drive signal (S_{St}) with regard to inductive coupling from the transponder (110) to the transceiver (100) to determine the occurrence of the response minimum field strength of the magnetic alternating field at the transponder (110), wherein the drive signal (S_{St}) corresponds to the association, signal when the response minimum field strength occurs.

5. The method according to claims 1 or 2, wherein the step of determining the association signal comprises the following sub-steps:
detecting the coupling effect of the transponder (110) caused by the inductive coupling between the transponder (110) and the transceiver (100) on the transceiver (100), wherein the coupling effect is a measure of the distance between the transponder (110) and the antenna means (102); and
generating the association signal based on the coupling effect detected, wherein the association signal has a direct portion (S₌) and/or and, alternating portion (S_{˜}).

6. The method according to claim, 5, wherein the direct portion (S₌) of the association signal is caused by a load created by the transponder (110) and detectable in the transceiver (100).

7. The method according to claims 5 or 6, wherein the alternating portion (S_{˜}) of the association signal is caused by a load modulation created by the transponder (110) and detectable in the transceiver (100).

8. The method according to claim 1, wherein determining the association signal takes place in the transponder (110).

9. The method according to claim 8, wherein an induction signal (S_{Trans,Rx}) is generated at antenna means (112) of the transponder (110) by the magnetic alternating field at the location of the transponder (110), and wherein the step of determining comprises the following sub-step:
determining the association signal based on the induction signal (S_{Trans,Rx}), wherein the association signal is transferable by means of inductive coupling from the transponder (110) to the transceiver (100).

10. The method according to claims 8 or 9, wherein in the step of determining the association signal a direct portion and/or an alternating portion of the association signal is determined.

11. The method according to claims 9 or 10, wherein the step of determining the association signal additionally comprises a step of digitalizing the induction signal.

12. The method according to one of claims 8-11, wherein when transferring the association signal, additionally the association signal may be integrated in a data transfer protocol between the transponder (110) and the transceiver (100).

13. The method according to one of the preceding claims, wherein the antenna means (102) comprises a plurality of antennas (500a-f), wherein each antenna (500a; 500b; 500c; 500d; 500e; 500f) may be driven separately and the step of determining the association signal is performable for each antenna (500a; 500b; 500c; 500d; 500e; 500f) of the plurality of antennas (500a-f).

14. The method according to claim 13, wherein a position of the transponder (110) is determined by means of the association signals of the plurality of antennas (500a-f).

15. The method according to claims 13 or 14, wherein the antennas (500a; 500b; 500c; 500d; 500e; 500f) of the plurality of antennas (500a-f) and an antenna (112) of the transponder (110) comprise coils with coil opening areas, wherein the magnetic field flows through the coil opening areas and the coil opening area of the transponder (110) is arranged in a respective fixed angle to the coil opening areas of the antenna means (102) of the transceiver (100).

16. The method according to one of claims 13-15, wherein the antennas (500a; 500b; 500c; 500d; 500e; 500f) of the antenna means (102) comprise coils having coil opening areas, wherein the magnetic field flows through the coil opening areas and the coils are arranged such that they form at least two at least approximately orthogonally arranged Helmholtz coil pairs and a transponder orientation is determined via an association signal representing a measure of inductive coupling, wherein an angle of the transponder (110) within the space spanned by the Helmholtz coil pairs may be associated to the inductive coupling.

17. The method according to one of claims 13 to 16, wherein determining a transponder orientation takes place such that the antennas (500a; 500b; 500c; 500d; 500e; 500f) of the antenna means (102) are driven simultaneously by means of drive signals of different phase positions to influence an orientation of the magnetic field within the space spanned by the antennas (500a; 500b; 500c; 500d; 500e; 500f) of the antenna means (102) and thus determine an association signal representing a measure of inductive coupling, wherein an angle of the transponder (110) within the space spanned by the antennas (500a; 500b; 500c; 500d; 500e; 500f) may be associated to the inductive coupling.

18. The method according to one of the preceding claims, comprising the steps of:
detecting the orientation of the transponder (110) with regard to the antenna means (102);
generating the magnetic alternating field based on the orientation detected so that the magnetic alternating field penetrates the transponder (110) in a predetermined angle; and
determining the distance from the transponder (110) to the antenna means (102).

19. The method according to claim 18, wherein the predetermined angle is in a range of 90°±30°.

20. A transceiver (100) in a radio system for determining the position or orientation of a transponder (110) by inductive coupling, comprising:
antenna means (102) for generating a magnetic alternating field;
means (104) for generating a drive signal (S_{St}) for driving the antenna means (102); and
processing means (108) formed to determine, with inductive coupling with a transponder (110), an association signal representing a measure of inductive coupling, wherein the inductive coupling may be associated to a distance or orientation of the transponder (110) to the transceiver (100).

21. The device according to claim 20, wherein the means (104) for generating the drive signal (S_{St}) is formed to vary the drive signal (S_{St}) with regard to amplitude to vary the field strength of the magnetic alternating field.

22. The device according to claims 20 or 21, wherein the transponder (110) comprises a read minimum field strength required for communication between the transponder (110) and the transceiver (100), and wherein the magnetic alternating field is generated by means of the transceiver 100 by a drive signal (S_{St}) for the antenna means (102), the processing means (108) further comprising:
means for varying the field strength of the magnetic alternating field via the drive signal (S_{St}); and
means for evaluating the drive signal (S_{St}) with regard to the communication between the transponder (110) and the transceiver (100) to determine the occurrence of the read minimum field strength of the magnetic alternating field at the transponder (110), wherein the drive signal (S_{St}) corresponds to the association signal when the read minimum field strength occurs.

23. The device according to claims 20 or 21, wherein the transponder (110) comprises a response minimum field strength required for an energy supply of the transponder (110), and wherein the magnetic alternating field is generated by means of the transceiver (100) by a drive signal (S_{St}) for the antenna means (102), and wherein the processing means (108) further comprises:
means for varying the field strength of the magnetic alternating field via the drive signal (S_{St}); and
means for evaluating the drive signal (S_{St}) with regard to inductive coupling from the transponder (110) to the transceiver (100) to determine the occurrence of the response minimum field strength of the magnetic alternating field at the transponder (110), wherein the drive signal (S_{St}) corresponds to the association signal when the response minimum field strength occurs.

24. The device according to claim 20, wherein the processing means (108) is formed to detect a coupling effect of the transponder (110) created by the inductive coupling between the transponder (110) and the transceiver (100) on the transceiver (100), wherein the coupling effect is a measure of the distance between the transponder (110) and the antenna means (102), and to generate an association signal based on the coupling effect detected, the association signal comprising a direct portion (S₌) and/or an alternating portion (S_{˜}).

25. The device according to claim 21, wherein an induction signal is generated at antenna means (112) of the transponder (110) by the magnetic alternating field at the location of the transponder (110), and wherein the processing means (108) further comprises:
means for determining the association signal based on the induction signal, wherein the association signal is transferable by means of inductive coupling from the transponder (110) to the transceiver (100).

26. The device according to one of claims 20 to 25, wherein the antenna means (102) includes an antenna in the form of a coil, wherein the coil comprises a coil opening area which magnetic alternating field flows through.

27. The device according to one of claims 20 to 26, wherein the antenna means (102) comprises a plurality of antennas (500a-f) in the form of coils, wherein the coils (500a; 500b; 500c; 500d; 500e; 500f) each comprise coil opening areas which the magnetic alternating field flows through.

28. The device according to claim 27, wherein the coils (500a; 500b; 500c; 500d; 500e; 500f) of the plurality of coils are arranged to one another such that two coil opening areas are each arranged in an angle in a range of 60°±15°.

29. The device according to claim 27, wherein the coils (500a; 500b; 500c; 500d; 500e; 500f) of the plurality of coils are arranged to one another such that two coil opening areas are each arranged in an angle in a range of 90°±15°.

30. The device according to claim 27, wherein two mutually opposite coils each of the plurality of coils (500a-f) are arranged such that the two coils form a Helmholtz coil pair.

31. The device according to claim 29, wherein the antenna means (102) further comprises a diagonal antenna (500e) in the form of a coil comprising both an angle of 45±10° relative to a first coil (500a) of the approximately orthogonally arranged coils and comprising an angle of 45°±10° relative to a second coil (500b) of the approximately orthogonally arranged coils.

32. The device according to one of claims 20 to 31, wherein the means (104) for generating the drive signal (S_{St}) for driving the antenna means is formed to drive each antenna (500a; 500b; 500c; 500d; 500e; 500f) of the plurality of antennas of the antenna means (102) in a temporally successive manner.

33. The device according to one of claims 20 to 32, wherein the means (104) for generating the drive signal (S_{St}) for driving the antenna means (102) is formed to drive all antennas (500a; 500b; 500c; 500d; 500e; 500f) of the plurality of antennas of the antenna means (102) simultaneously.

34. The device according to claim 33, wherein the means (104) for generating the drive signal (S_{St}) for driving the antenna means (102) is formed to generate drive signals of different phase positions for different antennas (500a; 500b; 500c; 500d; 500e; 500f) of the plurality of antennas of the antenna means (102).

35. A transponder (110) for determining a position or orientation comprising:
antenna means (112);
means (250) for providing an association signal (S_{Trans,Tx}) representing a measure of inductive coupling, wherein the inductive coupling may be associated to a distance or orientation of the transponder (110) to a transceiver (100), and wherein the association signal (S_{Trans,Tx}) is transferable to the transceiver (100) by means of inductive coupling.

36. The transponder according to claim 35, wherein the association signal corresponds to a rectified induction signal (S_{Trans,Rx}) generated at the antenna means (112) by the magnetic alternating field at the location of the transponder (110).

37. The transponder according to claims 35 or 36, wherein the means (250) for providing the association signal additionally comprises means (306) for digitalizing the induction signal (S_{Trans,Rx}) generated at the antenna means (112).

38. The transponder according to one of claims 35 to 37, wherein the means (250) for providing the association signal (S_{Trans,Tx}) further comprises means (308) for integrating the digitalized induction signal (S_{Trans,Rx}) induced at the antenna means (112) in a data transfer protocol to be able to transfer the association signal by means of inductive coupling to the transceiver (100).

39. A computer program having a program code for performing a method according to one of claims 1 to 19 when the computer program runs on a computer and/or microcontroller.
